(19) United States
(12) Patent Application Publication
(10) Pub. No.: US 2002/0161893 A1
(43) Pub. Date: Oct. 31, 2002

(54) Switched session management using local persistence in an automated and distributed replication system

(76) Inventor: Kelly J. Wical, St. Augustine, FL (US)

Correspondence Address: DORSEY & WHITNEY, LLP, SUITE 4700, 370 SEVENTEENTH STREET, DENVER, CO, 80202-5647, US

(21) Appl. No.: 09/790,668

(22) Filed: Feb. 23, 2001

Related U.S. Application Data
(60) Provisional application No. 60/237,611, filed on Oct. 4, 2000.

(51) Int. Cl. G06F 15/16

(52) U.S. Cl. 709/227; 709/224

(57) ABSTRACT

Switched session management to track and manage sessions executed across multiple machines as a result of a machine failure or other event in an automated and distributed replication system. To track the sessions, the system associates session information with a CacheID, stores the CacheID in the user's machine, and propagates the session information to a remote machine for processing. Machines taking over processing of the user's session can inspect the CacheID to determine whether to locally or remotely obtain the session information for the user.

### REFERENCE TO RELATED APPLICATIONS

The present application is related to the following applications, all of which are incorporated herein by reference as if fully set forth: United States provisional patent application of Kelly Wical, entitled “Apparatus and Method for Managing Electronic Commerce Transactions in an Automated and Distributed Replication System,” and filed on Oct. 4, 2000; United States patent application of Kelly Wical, entitled “Caching System Using Timing Queues Based on Last Access Times,” and filed on even date herewith; and United States patent application of Kelly Wical, entitled “Batch Processing System Running in Parallel on Automated and Distributed Replication Systems,” and filed on even date herewith.

### FIELD OF THE INVENTION

The present invention relates to an apparatus and method for managing electronic transactions within automated and distributed replication systems and other environments. It relates more particularly to a system for switched session management in the automated and distributed replication systems or other environments.

### BACKGROUND OF THE INVENTION

Systems for processing electronic transactions often include multiple levels of redundancy of servers, other machines, and databases. The redundancy means that, if one machine fails, other machines may take over processing for it. The use of multiple levels of machines provides for distributing a load across many machines to enhance the speed of processing for users or others. In addition, the use of replicated databases can help to ensure the availability of data in the event of machine failure. The use of multiple levels of machines and replicated databases requires management of processing among them.

For example, each machine typically may have its own local cache and other stored data in memory. Management of a local cache in memory typically must be coordinated with the cache and memory of the other machines processing all of the electronic transactions. Therefore, use of multiple machines and levels requires coordination and synchronization of data in replicated databases among the machines in order to most effectively process electronic transactions without errors.

### SUMMARY OF THE INVENTION

An apparatus and method consistent with the present invention provides for switched session management in an automated and distributed replication system or other environments. The apparatus and method detect a session from a user. In response, a machine identifier related to the user is obtained, and session information is selectively obtained for the user based upon the machine identifier. The session is selectively processed based upon the session information.

### BRIEF DESCRIPTION OF THE DRAWINGS

The accompanying drawings are incorporated in and constitute a part of this specification and, together with the description, explain the advantages and principles of the invention. In the drawings,

FIG. 1 is a block diagram of an exemplary automated and distributed replication system for processing electronic transactions;

FIG. 2 is a diagram of exemplary components of machines in the automated and distributed replication system;

FIG. 3 is a diagram of exemplary components used within the machines for switched session management;

FIG. 4 is an example of a user screen for a user to interact with the system during switched session management;

FIGS. 5A and 5B are a flow chart of a session management routine; and

FIG. 6 is a flow chart of a load balancing routine that can run in parallel with the session management routine.

### DETAILED DESCRIPTION

### Automated and Distributed Replication System

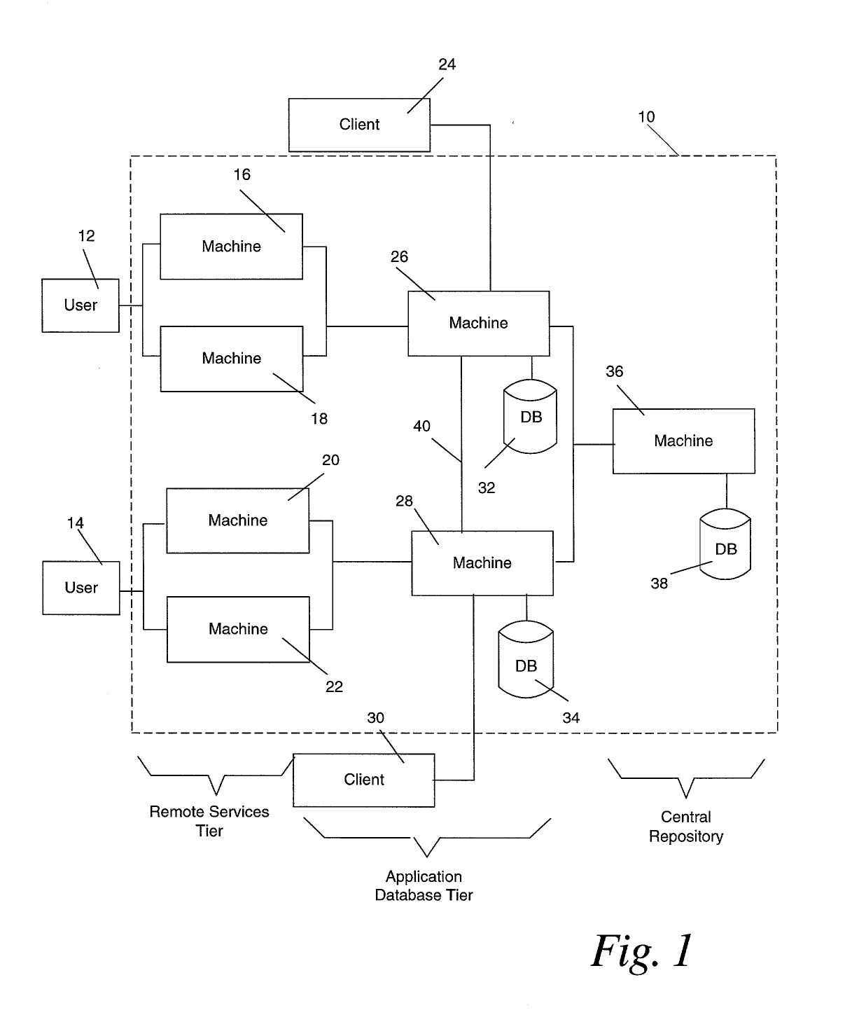

FIG. 1 is a diagram of an example of an automated and distributed replication system 10 for processing electronic transactions. System 10 includes machines 16 and 18 for processing electronic transactions from a user 12, and machines 20 and 22 for processing electronic transactions from a user 14. Users 12 and 14 are each shown connected to two machines for illustrative purposes only; the user would typically interact at a user machine with only one of the machines (16, 18, 20, 22) and would have the capability to be switched over to a different machine if, for example, a machine fails. Users 12 and 14 may interact with system 10 via a browser, client program, or agent program communicating with the system over the Internet or other type of network.

Machines 16 and 18 interact with a machine 26, and machines 20 and 22 interact with a machine 28. Machines 26 and 28 can communicate with each other as shown by connection 40 for processing electronic transactions, and for coordinating and synchronizing the processing. In addition, machine 26 can receive electronic transactions directly from a client 24 representing a client machine or system. Machine 28 can likewise receive electronic transactions directly from a client 30. Clients 24 and 30 may communicate with system 10 over the Internet or other type of network.

Machines 26 and 28 interact with a machine 36, which functions as a central repository. Machines 26 and 28 form an application database tier in system 10, and machines 16, 18, 20 and 22 form a remote services tier in system 10. Each machine can include an associated database for storing information, as shown by databases 32, 34, and 38. System 10 can include more or fewer machines in each of the tiers and central repository for additional load balancing and processing for electronic transactions. The operation and interaction of the various machines can be controlled in part through a properties file, also referred to as an Extensible Markup Language (XML) control file, an example of which is provided in the related provisional application identified above.

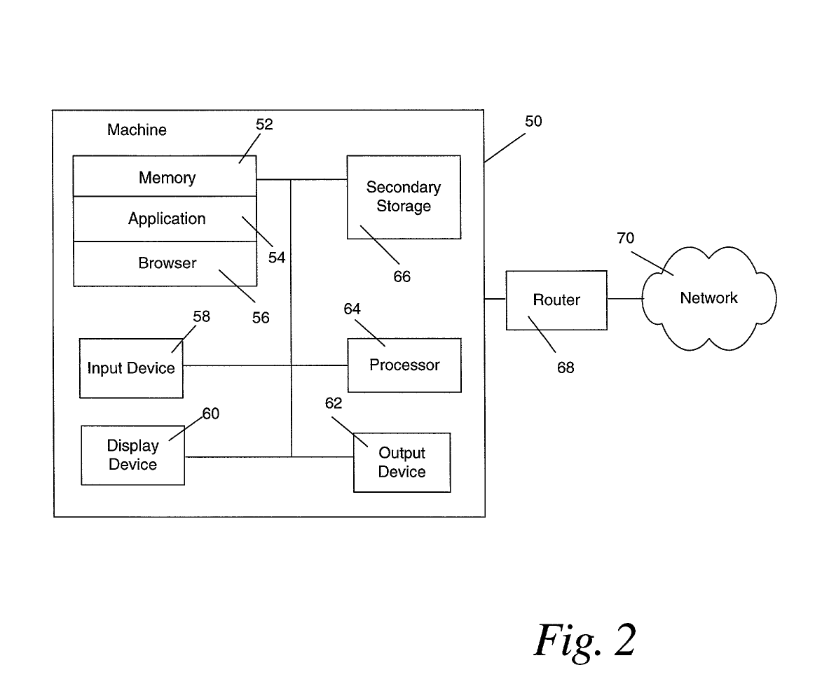

FIG. 2 is a diagram of a machine 50 illustrating exemplary components of the machines shown and referred to in FIG. 1. Machine 50 can include a connection with a network 70 such as the Internet through a router 68. Network 70 represents any type of wireline or wireless network. Machine 50 typically includes a memory 52, a secondary storage device 66, a processor 64, an input device 58, a display device 60, and an output device 62.

Memory 52 may include random access memory (RAM) or similar types of memory, and it may store one or more applications 54 and possibly a web browser 56 for execution by processor 64. Applications 54 may correspond with software modules to perform processing for embodiments of the invention such as, for example, agent or client programs. Secondary storage device 66 may include a hard disk drive, floppy disk drive, CD-ROM drive, or other types of non-volatile data storage. Processor 64 may execute applications or programs stored in memory 52 or secondary storage 66, or received from the Internet or other network 70. Input device 58 may include any device for entering information into machine 50, such as a keyboard, key pad, cursor-control device, touch-screen (possibly with a stylus), or microphone.

Display device 60 may include any type of device for presenting visual information such as, for example, a computer monitor, flat-screen display, or display panel. Output device 62 may include any type of device for presenting a hard copy of information, such as a printer, and other types of output devices include speakers or any device for providing information in audio form. Machine 50 can possibly include multiple input devices, output devices, and display devices. It can also include fewer components or more components than shown, such as additional peripheral devices, depending upon, for example, particular desired or required features of implementations of the present invention.

Router 68 may include any type of router, implemented in hardware, software, or a combination, for routing data packets or other signals. Router 68 can be programmed to route or redirect communications based upon particular events such as, for example, a machine failure or a particular machine load.

Examples of user machines, represented by users 12 and 14, include personal digital assistants (PDAs), Internet appliances, personal computers (including desktop, laptop, notebook, and others), wireline and wireless phones, and any processor-controlled device. The user machines can have, for example, the capability to display screens formatted in pages using browser 56, or client programs, and to communicate via wireline or wireless networks.

Although machine 50 is depicted with various components, one skilled in the art will appreciate that this machine can contain different components. In addition, although aspects of an implementation consistent with the present invention are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or read-only memory (ROM). The computer-readable media may include instructions for controlling machine 50 to perform a particular method.

### Switched Session Management Using Local Persistence in an Automated and Distributed Replication System

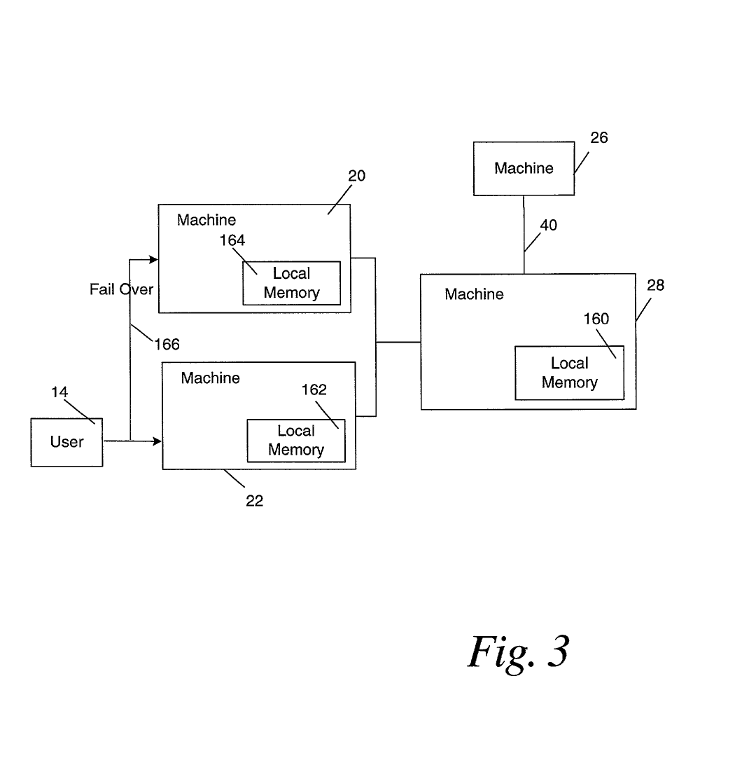

FIG. 3 is a diagram of exemplary components in the machines used for switched session management for processing electronic transactions. Each machine can include a local memory to store information for a user's session such as, for example, a user's purchases, orders, requests, or other relevant information. Machine 28 includes a local memory 160, machine 20 includes a local memory 164, and machine 22 includes a local memory 162. One example of a local memory is referred to as a “shopping basket” for recording information concerning on-line purchases; however, a user's session can involve any type of electronic transaction, other than or in addition to on-line purchases. The local memories 160, 162, and 164 can be implemented with, for example, local caches or any other type of data storage element associated with the corresponding machine.

User 14 through a user machine can interact with machine 22 via a client program, during which time information for the user's session is recorded in local memory 162. The client program can include, for example, any type of application program used to assist in processing any electronic transaction for the user or others. Such information can include any type of information for processing the user's session. If machine 22 fails, the user's session, as illustrated by connection 166, switches over to machine 20 for processing. The switching of the user's session requires coordination between the user information as recorded in local memory 162 and the user's new information recorded in local memory 164 after the switch over.

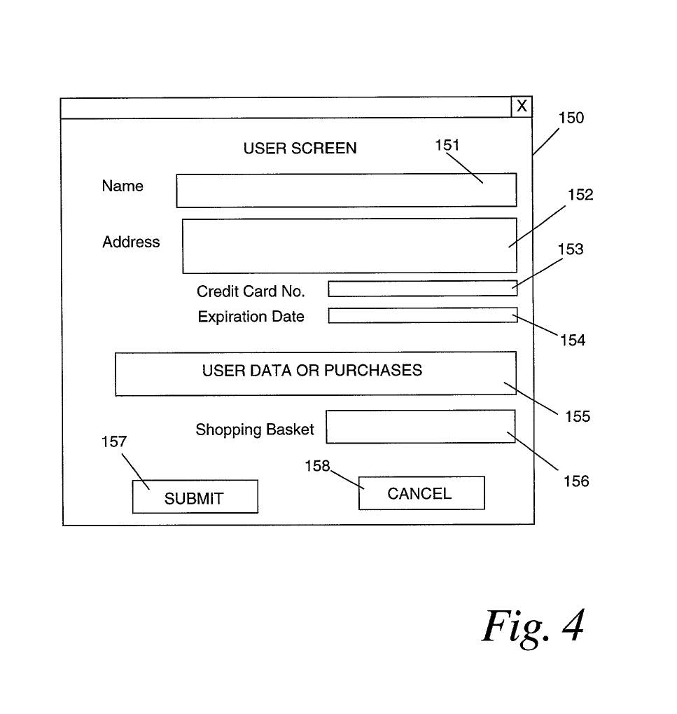

FIG. 4 is an example of a user screen displaying a page 150 for a user to interact with the system during switched session management to enter purchases or other information. Page 150 can be formatted, for example, as a HyperText Markup Language (HTML) page and presented on display device 60 in a user machine by browser 56. Page 150 can include, for example, a name section 151 for entering a user name, an address section 152 for entering a user address, and sections 153 and 154 for entering a credit card number and an associated expiration date. The user can enter data or identify on-line purchases in a section 155. Certain transactions, for example, can involve a change in data without including any purchases. A shopping basket section 156 can identify or record total purchases and provide the user with a visual representation of the information, or a sub-set of the information, stored in local memories 162 and 164. The user can submit the entered information by selecting a submit section 157 or cancel the transaction by selecting a cancel section 158. Page 150 is an example of a user page and is provided for illustrative purposes only; a user at machine 14 can enter information through any user screen presenting data.

That user screen can have more or fewer sections, and a different arrangement of sections, than shown in page 150. Also, certain electronic transactions do not necessarily require interaction through a screen or page, and information can be entered in other ways for those transactions.

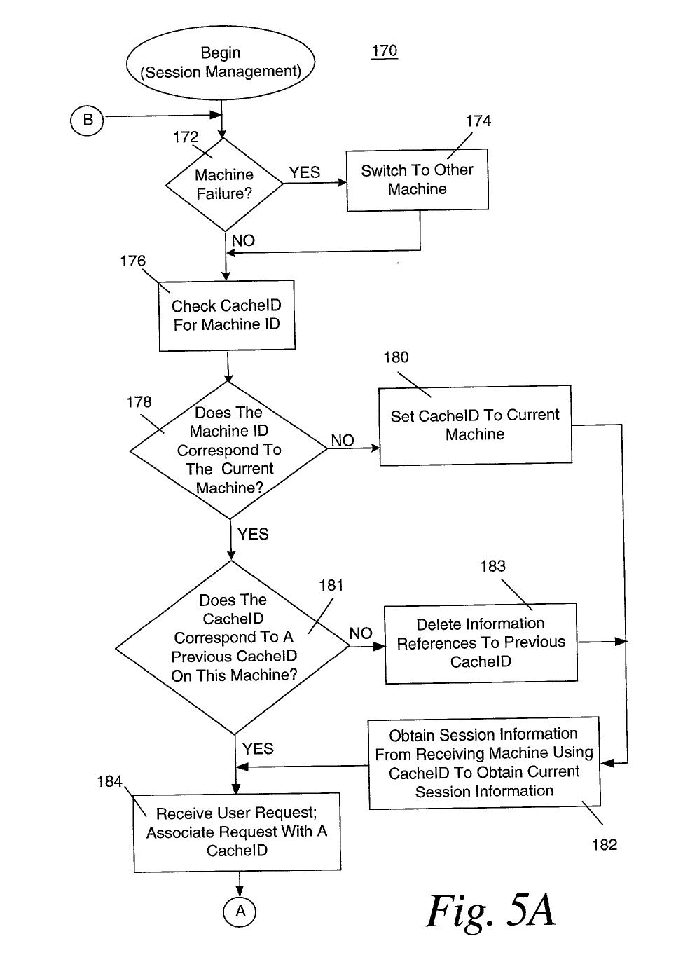

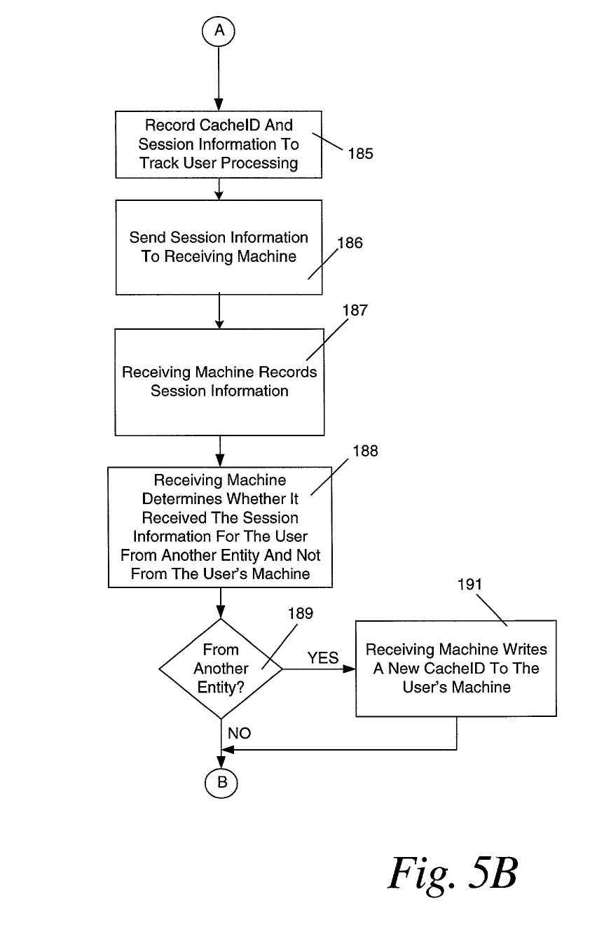

FIGS. 5A and 5B are a flow chart of a session management routine 170 for managing the switch over of the user's session following a machine failure or other event. Routine 170 can be implemented, for example, in software modules in the machines in the remote services tier, as shown in FIG. 3, processing a user's session. In routine 170, the system determines if a machine has failed (step 172); if so, the user's session is automatically switched over to another machine in system 10 (step 174). Routers, and traffic or load directors, within the system can be programmed to switch the user's session automatically upon detection of a machine failure. Alternatively, the central repository can programmatically monitor the system and switch users' sessions upon detecting machine failures or other events; the switching of machines can occur according to particular criteria identifying, for example, the machines to take over processing of users' sessions.

The current machine in the remote services tier communicating with the user checks a machine identifier (ID) in a CacheID, for example, in the user's machine (step 176) and determines if the machine ID corresponds to the current machine (step 178). The machine ID can be implemented, for example, with a unique number identifying a particular instance with a machine (node) in the system. An agent or client program operating on the user's machine can generate the unique machine ID by, for example, receiving a machine number and adding a sequential number to it. The agent program can signal the machine with the assigned machine ID to perform the comparison in step 178.

If the machine ID in the CacheID does not correspond to the current machine, it means that another machine had been processing the user's session. In that case, the current machine sets the machine ID in the user's CacheID to its machine ID, and a new CacheID is stored in a local memory associated with the user's machine (step 180). If the machine ID corresponds with the current machine, then the current machine also checks the CacheID to determine if it matches a previous CacheID, if any, in the user's machine (step 181).

If the CacheID does not correspond with a previous CacheID, it means that, for example, another entity changed information for the user's session. In particular, the entity that changed the information writes, or causes to be written, a new CacheID to a local memory associated with the user's machine, indicating that the user's session information has changed. The client or agent program on the user's machine can record CacheIDs, for example, and thus compare previous CacheIDs with the current CacheID in the local memory for the user machine. If the agent program detects a new CacheID, meaning that it does not correspond with a previous CacheID, it knows that the user's session information has changed and that it therefore must obtain new session information. The new session information in this example is obtained from another machine, as that entity can maintain current session information for users.

As an example, the application database may receive a monetary credit to issue to the user's credit card account. It receives the credit from another entity, not the user's machine, as the credit is typically entered by a merchant and processed on-line through a financial institution. The application database updates its stored session information for the user to issue the credit and writes a new CacheID to the user's machine, indicating the change in session information. Upon detecting the new CacheID, the user's machine obtains the new session information, including the credit, from the application database and can thus update the locally cached session information to include the credit. For example, the user's machine can notify the user of the credit through page 150 and adjust the user's total amount for the purchases to include the credit. This example provides one scenario for illustrative purposes only, and various entities in or associated with the system can change a user's session information for any purpose.

If the current machine detected that the CacheID does not correspond with a previous CacheID (step 181), the user's machine deletes any session information references to the previous CacheID (step 183). Each CacheID can have, for example, references or links to information for use in processing the user's session, such as, for example, the information entered through page 150 or information entered in other ways. After steps 180 and 183, the user's machine obtains session information from a receiving machine such as, for example, a machine in the application database to obtain the current session information for the user's session or electronic transaction (step 182). The CacheIDs can have or be associated with a user ID, and the current machine can use the user ID, or other information, from the CacheID or previous CacheID to obtain the user's current session information from the receiving machine.

The term “session information” includes any information associated with an order, a user request, a user session, an electronic transaction, or a sub-set of such information. Each session is associated with a CacheID to track the user's session information for the sessions, or electronic transactions, and determine when new information exists for the user's session.

If the current machine detected that the machine ID corresponds with the current machine (step 178) and the CacheID corresponds with a previous CacheID (step 181), then the current machine can obtain the session information locally. In other words, if both conditions from steps 178 and 181 are satisfied, it means that the current machine has been processing the user's session and that another entity has not entered or otherwise changed the information for the user's session.

The current machine can receive user requests or other information as entered, for example, using page 150 shown in FIG. 4, any user screen presenting data, or through other input devices or ways (step 184). The current machine associates session information with a CacheID (step 184). It can use any type of one-to-one, one-to-many, or many-to-many relationships between session information and CacheIDs. For example, it can associate multiple pieces of information during the same session with the same CacheID. The current machine records, by locally caching in this example, the CacheID generated for the session information to track user processing (step 185). The current machine sends session information to the receiving machine for recording in local memory 160, for example (step 186). The receiving machine records the session information associated with the user (step 187).

The receiving machine also determines whether it received the session information for the user from another entity and not from the user's machine (steps 188 and 189). The receiving machine can compare the machine ID for the received session information with the machine ID for previously-received session information for the user. In particular, the receiving machine identifies the machine processing the user's session and also identifies the machine originating the new incoming information for the user. The receiving machine, therefore, can in effect compare the current user with the originating user of the incoming information. If the machine IDs do not match, then the receiving machine signals the user's machine that the session information for the user has changed. For example, the application database can write a new CacheID to the local memory associated with the user's machine to indicate that new session information exists (step 191). Therefore, when step 181 is executed again, as method 170 repeats, the user's machine will detect that another entity changed the user's session information and that it must update the locally cached information by obtaining the new session information from the receiving machine. Alternatively, another machine could directly update the user's machine.

The CacheID in the user's machine identifies the last machine processing its session and whether another entity updated the user's session information. Other machines can check the CacheID to determine if another machine had processed the user's session. The receiving system such as, for example, the application database maintains the current session information for the user as received by each machine processing the user's session, and the information in the receiving system is not specific to a particular CacheID or machine. The CacheID thus provides a key to the most current session information for a particular user and can be retrieved by machines processing the user's session. As the user's session is potentially switched from machine-to-machine, each machine can obtain the most current session information from the receiving system such as, for example, the application database by inspecting the CacheID retrieved from the user's local memory to determine if it needs to obtain the session information from the receiving system instead of from the local database for the user's machine. In addition, if the receiving machine updates the user's session information based upon information received from another entity, it can signal the user's machine through, for example, a new CacheID written to the user's machine; alternatively, another machine can directly update the user's machine. Therefore, the machines processing the user's session can inspect the CacheID for the user in order to determine how to retrieve the most current session information for the user's session.

Tables 1-4 illustrate an example of the recording of session information for tracking a user's transactions across multiple machines in system 10. The information shown in Tables 1-4 can be implemented with any type of data structure such as, for example, a relational database, XML strings, or an XML database interacting with an underlying relational database.

Table 1 illustrates the recording of a user's session information on machine 1. In this example, the CacheID contains both an identification of the machine processing the session, the first number, and the session itself, the second number. For example, CacheID 1-101 represents machine 1 processing session 101. The term “CacheID” is used only as a label and includes any type of information for identifying the machine and session.

When the user's session switches to machine 2, as a result of machine 1 failure for example, machine 2 changes the CacheID and obtains a new session ID from the user's machine, as shown in Table 2. In this example, machine 2 changes the order amount as a result of additional purchases requested by the user during the session on machine 2.

When machine 1 comes back on-line and if the user eventually switches back to machine 1, it detects a different CacheID, indicating that the user's session was processed by a different machine, as indicated by the “2” in the CacheID. In response, machine 1 obtains the user's session information from the application database and thus obtains the new order amount including the most recent transaction information for the user, as shown in Table 3.

The user ID and session ID shown in the tables can be implemented, for example, with sequential numbers uniquely identifying the users and sessions. The term “session” refers to processing occurring from a particular machine. In this example, when the system (application database, for example) first detects communication from a particular machine, it sends, for example, a cookie, an ID, or other information to the local memory of the machine to identify the session. As the user returns on-line at various times, the system can identify the same session from this particular machine as long as the cookie, the ID, or other information is still present in the user machine.

As an alternative to the use of sequential numbers, the machine ID, user ID, and session ID can be implemented with any unique identifier such as, for example, numbers, characters, symbols, or a combination of them.

TABLE 1
user session (machine 1)

| | |
|---|---|
| user ID = | 10 |
| CacheID = | 1-100 |
| session ID = | 5 |
| order amount = | $20 |

TABLE 2
user session (machine 2 takes over)

| | |
|---|---|
| user ID = | 10 |
| CacheID = | 2-101 |
| session ID = | 5 |
| order amount = | $20→$21 |

TABLE 3
user session (machine 1 back on-line and if the
user's session switches back to machine 1)

| | |
|---|---|
| user ID = | 10 |
| CacheID = | 1-102 |
| session ID = | 5 |
| order amount = | $20→$21 |

Table 4 illustrates an example of an order table maintained by the receiving system such as, for example, the application database. It associates each CacheID with the corresponding order amount and updates the table as it receives information from the machines processing the user's session. The order table is provided for illustrative purposes only and, as indicated above, session information can include many different types of information in addition to or other than orders.

TABLE 4
order table

| entry | CacheID | order amount |
|---|---|---|
| 1 | 1-100 | $20 |
| 2 | 2-101 | $21 |
| 3 | 1-102 | $20→$21 |

### Load Balancing

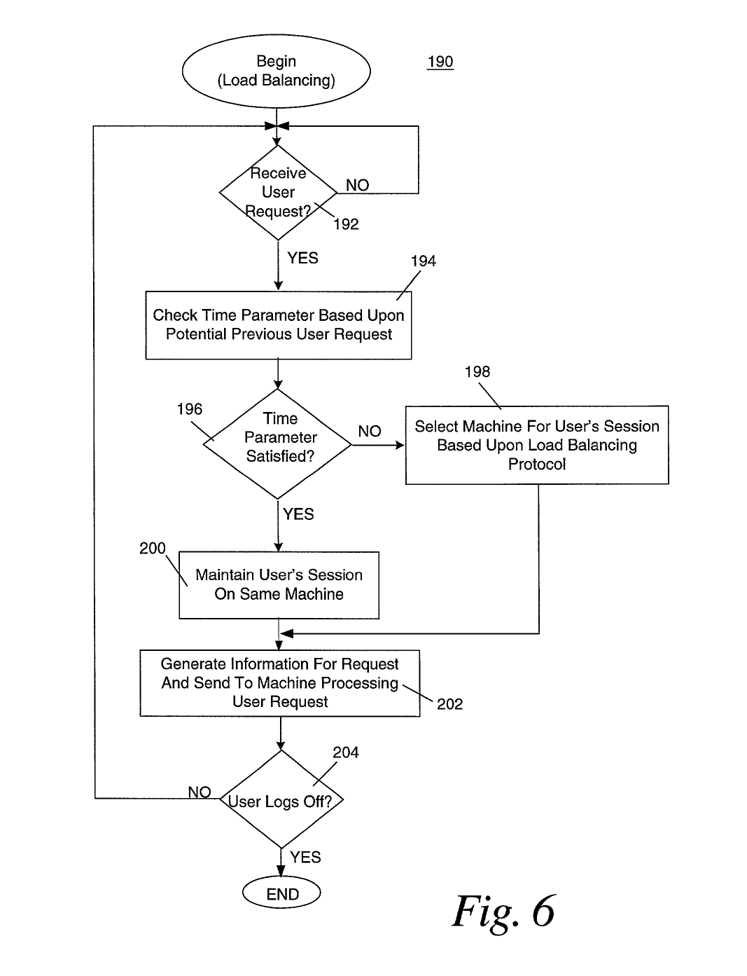

FIG. 6 is a flow chart of a load balancing routine 190 that can run in parallel with session management routine 170. Routine 190 can be implemented, for example, in software modules executed among the machines in system 10, as shown in FIG. 1. Load balancing involves determining and selecting machines such as, for example, machines in the remote services tier for processing users' sessions. The term “load” refers to the aggregation of the users' sessions to be processed. With multiple machines in the remote services tier, for example, system 10 can distribute the load across those machines according to particular criteria or protocols. For example, the load can be evenly distributed to provide the most efficient processing of user sessions and to ensure that no single machine becomes over-burdened with processing user sessions. Providing for even distribution can also require frequently switching user sessions among machines. Since each remote services tier machine, for example, locally caches information for each user session, frequent switching of sessions can result in a more frequent need to obtain information over a network as it will not be locally cached.

Load balancing routine 190 provides for distributing the load according to criteria that includes consideration of both the advantage of using locally cached information and attempting to prevent over-burdening any one machine. In routine 190, the system determines whether it receives a user request from one of the user machines (step 192). The user request can include any type of electronic transaction. If it receives a user request, the system checks a time parameter based upon a potential previous request from the same user machine (step 194). In particular, the system determines whether it received a request from the same user machine within a particular time period. In an exemplary embodiment, the system determines if the current request occurs within twenty minutes of a previous request from the same user machine; however, any time period can be used.

If the time parameter is satisfied (step 196), meaning that the new request was received within the particular time period from the previous request, the system maintains the user's session on the same machine such as, for example, the same remote services tier machine (step 200). Otherwise, if the time parameters is not satisfied, the system selects a machine to process the user's session based upon a load balancing protocol (step 198). Load balancing protocols are known in the art for distributing a load across multiple machines according to particular criteria, and any load balancing protocol can be used in conjunction with consideration of the time parameter.

The system generates information such as a page, for example, for responding to the user request and sends the information to the machine processing the user's session (step 202). Unless the user logs off (step 204), the system continues executing load balancing routine 190 for additional user requests and executes it for multiple users.

Load balancing routine 190 can be executed among any machines such as, for example, the machines in the application database tier or in the machine(s) of the central repository. These machines can record in a load balancing table an indication of the users, the remote services (RS) tier machines processing their requests, and their times for a previous request. The times of the previous requests can be compared with a current time to check the time parameter in steps 194 and 196. The information in the load balancing table can also be used to identify the machine previously processing a user's request for step 200.

Table 5 provides an example of a data structure for specifying this information for access by the machines executing routine 190. The information in Table 5 can be stored in a relational database, XML database, or a combination, or in other types of data structures. In addition, the properties file can specify the same information for use in executing the load balancing routine. The information can be updated as user sessions are switched among machines to track the session processing for the load balancing.

TABLE 5

| | RS tier machine | |
|---|---|---|
| user | processing user session | time of last user request |
| user ID 1 | machine ID 1 | time 1 |
| user ID 2 | machine ID 2 | time 2 |
| . . . | | |
| user ID N | machine ID N | time N |

While the present invention has been described in connection with an exemplary embodiment, it will be understood that many modifications will be readily apparent to those skilled in the art, and this application is intended to cover any adaptations or variations thereof. For example, different labels for the various modules and databases, and various hardware embodiments for the machines, may be used without departing from the scope of the invention. This invention should be limited only by the claims and equivalents thereof.

1. A method for switched session management in an automated and distributed replication system, comprising:
detecting a session by a user;
obtaining a machine identifier related to the user;
selectively obtaining session information for the user based upon the machine identifier; and
selectively processing the session based upon the session information.

2. The method of claim 1 wherein the selectively obtaining step includes obtaining the session information locally.

3. The method of claim 1 wherein the selectively obtaining step includes obtaining the session information from a remote machine.

4. The method of claim 1 wherein the obtaining the machine identifier step includes obtaining a cache identifier identifying a machine processing the session.

5. The method of claim 4, further including updating the cache identifier to identify a different machine processing the session.

6. The method of claim 1 wherein the detecting step includes receiving a request for an electronic transaction from the user.

7. The method of claim 1, further including associating the session with an identifier.

8. The method of claim 1 wherein the selectively obtaining step includes:
detecting an indication of a modification of the session information for the user; and
obtaining the modified session information from a remote machine in response to the detecting.

9. The method of claim 1, further including:
associating the session information with the user; and
transmitting the session information to a remote machine.

10. The method of claim 1, further including selecting a machine to process the request based upon a time parameter related to a previous request by the user.

11. An apparatus for switched session management in an automated and distributed replication system, comprising:
a detect module for detecting a session by a user;
a machine module for obtaining a machine identifier related to the user;
a session module for selectively obtaining session information for the user based upon the machine identifier; and
a process module for selectively processing the session based upon the session information.

12. The apparatus of claim 11 wherein the session module includes a module for obtaining the session information locally.

13. The apparatus of claim 11 wherein the session module includes a module for obtaining the session information from a remote machine.

14. The apparatus of claim 11 wherein the machine module includes a module for obtaining a cache identifier identifying a machine processing the session.

15. The apparatus of claim 14, further including a module for updating the cache identifier to identify a different machine processing the session.

16. The apparatus of claim 11 wherein the detect module includes a module for receiving a request for an electronic transaction from the user.

17. The apparatus of claim 11, further including a module for associating the session with an identifier.

18. The apparatus of claim 11 wherein the session module includes:
a module for detecting an indication of a modification of the session information for the user; and
a module for obtaining the modified session information from a remote machine in response to the detecting.

19. The apparatus of claim 11, further including:
a module for associating the session information with the user; and
a module for transmitting the session information to a remote machine.

20. The apparatus of claim 1, further including a module for selecting a machine to process the request based upon a time parameter related to a previous request by the user.
